(19) United States
(12) Patent Application Publication
(10) Pub. No.: US 2009/0018852 A1
(43) Pub. Date: Jan. 15, 2009

(54) METHOD OF WIDE AREA NETWORK COMPETITION

(76) Inventor: Dianne Victor, West Bloomfield, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/854,089

(22) Filed: Sep. 12, 2007

Related U.S. Application Data
(60) Provisional application No. 60/949,044, filed on Jul. 11, 2007.
(60) Provisional application No. 60/951,273, filed on Jul. 23, 2007.

(51) Int. Cl. G06Q 90/00

(52) U.S. Cl. 705/1

(57) ABSTRACT

An example method of conducting a competition over a wide area network includes the steps of receiving a fee from at least one user, allocating a quantity of potential votes to the user based on the fee, providing competition entries for evaluation by the user, and receiving a vote from the user corresponding to one of the competition entries. The method may award the competition entry receiving the highest number of votes. The award may include a portion of the fee.

### CROSS REFERENCE TO RELATED APPLICATIONS

This application claims priority to U.S. Provisional Application No. 60/949044, which was filed on 11 Jul. 2007, and to U.S. Provisional Application No. 60/951273, which was filed on 23 Jul. 2007.

### BACKGROUND OF THE INVENTION

This invention relates to a wide area network competition, and more particularly to rewarding contestants involved in a reality-based wide area network competition.

Competitions are a popular source of entertainment. Some television programs include elimination-type competitions between two or more contestants. The competitions may involve contestant vocal performances, for example. Television viewers evaluate the vocal performances and vote via telephone for their favorite contestant. Panelists may provide additional critique and analysis of the performances. Eliminating contestants from the competition involves adding together the viewer votes for each contestant and may include other criteria, such as factoring in votes from the panelists. The contestant with the lowest number of votes is removed after each round of competition. The eventual competition winner receives a monetary award.

Reality-based competitions are usually unscripted and do not involve professional actors. Typical reality-based competitions do not limit the votes cast by an individual viewer. Also, the number of votes does not affect the award. Accordingly, many viewer voting strategies involve voting for a favorite contestant as many times as possible after each round, which may discourage other potential voters because the viewers with the most time to vote most influence the competition winner.

Television programs generally broadcast at predetermined times depending on scheduling. Potential viewers may miss the program, an opportunity to vote, or both, depending on their availability. As advertising sales generate some revenue for television programs, limiting the viewing audience exposed to advertising reduces potential revenue.

### SUMMARY

An example method of conducting a competition over a wide area network includes the steps of receiving a fee from at least one user, allocating a quantity of potential votes to the user based on the fee, providing competition entries for evaluation by the user, and receiving a vote from the user corresponding to one of the competition entries. The method may award the competition entry receiving the highest number of votes. The award may include a portion of the fee.

The example method of conducting a wide area network competition may include the steps of receiving a fee from users, providing access to a website for review of competition entries by the users, allocating potential votes to the users based on the user access fees, receiving a vote for one of the plurality of competition entries from one of the users, and preventing receipt of a vote based on a number of allocated potential votes.

These and other features of the application can be best understood from the following specification and drawings, the following of which is a brief description.

### BRIEF DESCRIPTION OF THE DRAWINGS

FIG. 1 shows the flow of an example method of awarding contestants involved in a wide area network competition.

FIG. 2 shows the general flow of an example method of wide area network competition that awards contestants using the FIG. 1 method.

FIG. 3 schematically shows an example interface for interacting with the FIG. 2 method.

### DETAILED DESCRIPTION OF AN EXAMPLE EMBODIMENT

An example method 10 of awarding contestants a wide area network-based competition includes receiving fees from potential voters at 14 in exchange for registering each of the potential voters as a competition voter. The method 10 then allocates potential votes to the voter based on the voter fee at 18. Allocation may include distributing more potential votes to a voter paying a higher fee and less potential votes to a voter paying a lower fee.

The competition includes multiple rounds. Some of the rounds involve voter interaction over the wide area network, which generally refers to the internet, but could apply to any open, publicly accessible network. At the close of each round, the voters cast votes for a competition entry at 22 and 26. Voting reduces the total potential votes held by the voter. Money or another suitable reward is added to a prize pool for each of the competition entries at 30 and 34 in an amount or ratio corresponding to the total number of votes received by that competition entry in that round. The competition entry with the lowest vote total is eliminated at the close of each of the round at 38 and 42.

Owners of the eliminated competition entries receive money from their prize pool at 46 representing the total number of votes received by the eliminated competition entry during each round of the competition. Accordingly, avoiding elimination gives the competition entry a chance to increase their prize pool by receiving additional votes in later rounds. Other examples may award prize pool money only corresponding to votes received in the final round of competition at 46.

The competition awarding contestants in accordance with the example method 10 is a reality-based competition. FIG. 2 illustrates the general flow of a method of wide area network-based reality-based competition 50 marketed as Innovator USA, Inc. for example. The method 50 emphasizes increased awareness of global issues and the global economy while stressing the importance of new innovation in sectors such as Science, Healthcare, Information Technology, Engineering, Environment, Communications, Media, Entertainment, Global Economy, Global Politics, Poverty, Security, or Future Consumer. The example method 50 seeks competition entries directed toward solutions to problems in one or more of these sectors.

The method 50 first includes a panel review of several entries at 54. The panel chooses particular entries for inclusion in remaining portions of the competition. The panel may include business leaders, college professors, and known global activists with expertise in one or more of the sectors. The example method 50 is set up to run on a yearly basis, selecting the panel typically takes place once per year.

To help choose particular entries, the panel reviews online essay applications and chooses a specified number of contestants from the entries for remaining portions of the competition, say 1,000 contestants from 100,000 initial applicants. As the example method 50 takes place annually, the panel reviews applicants for the competition annually.

During the initial stages of the panel review at 54, employees of the competition distribute marketing materials at 58 to prompt more applicants and pique public interest in remaining portions of the competition. The marketing materials include targeted marketing packages that are distributed to businesses, high schools, colleges, and major media outlets announcing Innovator USA, panel members, and rules. In this example, the initial applicants are 16 to 25 years of age at the time of the application, are U.S. citizens, and have an application worthy of panel review. Potential applicant target groups for other wide area network competitions include Boomer Innovators (for older applicants); African, Irish, Chinese, Indian, etc. Innovators (for applicants in other countries); and Global or International Innovators (for worldwide competitions). Although described as a competition among innovators, the example method 50 may be similarly applied to other types of contests awarding other groups.

After eliminating some of the initial applicants from the competition based on the review at 54, the example method 50 distributes webcams, or similar suitable technology, to the applicants at 62. The applicants use the webcams to record video explanations detailing their particular competition entry. The Innovator USA Mentor Panel will then conduct another review and choose another smaller group, say 300 of the 1,000, to become contestants and compete in the remaining portions of the competition at 66.

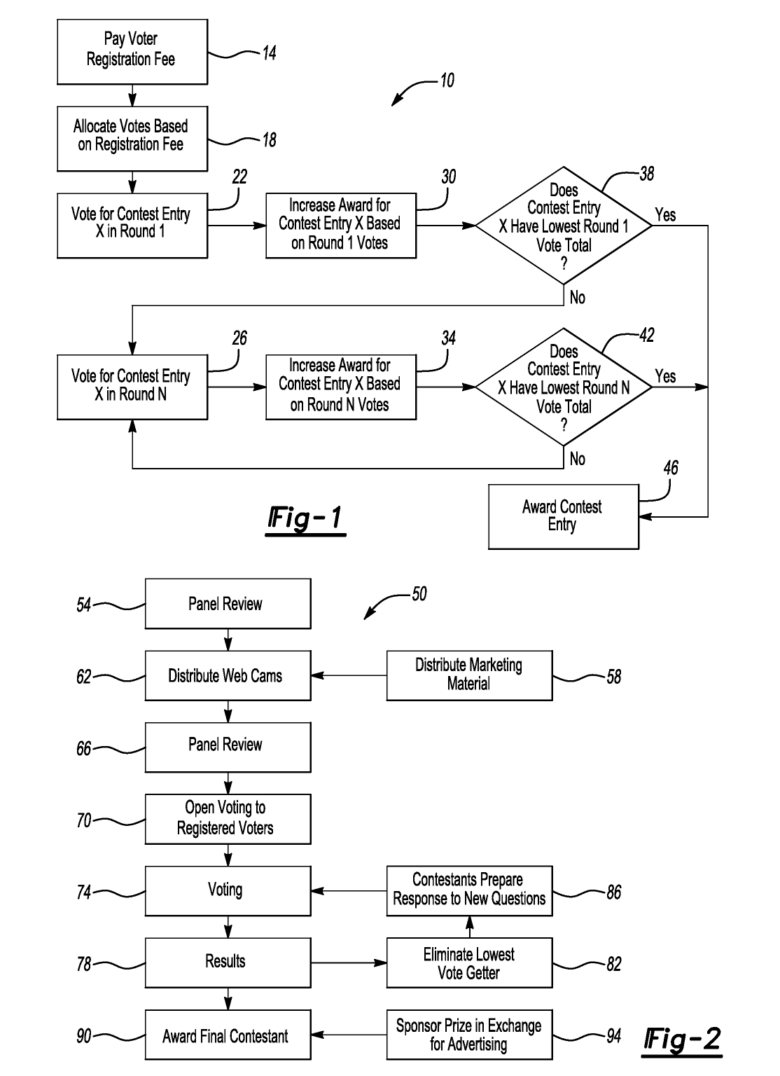

Registered voters at 70, such as the registered voters described in the FIG. 1, narrow this smaller group of contestants. Registered voters cast votes for particular contestants using a web-based interface. Those contestants with entries having the lowest number of votes from the registered voters are eliminated from the competition. A person skilled in the art and having the benefit of this disclosure would be able to develop a web-based interface suitable for collecting and tabulating votes from one or more registered voters.

The video explanations of contestant entries are broadcast through a website, thirty per day for two weeks for example, and results of the voting are posted on the website at 78. The explanations appear in a random order on the website. Other examples may include registered voters selecting a particular competition entry to view. Such an approach facilitates viewing competition entries when the registered voters' schedules permit.

After two weeks, the round of voting closes and the contestant entry or entries with the lowest number of votes are eliminated at 82. The method 50 displays vote totals for the remaining contestants, as well as the votes received by the contestants voted out of the competition. The remaining contestant entries advance to the next round. During each round, the contestants provide answers in response to topical questions formulated by the panel. The contestants use the webcams to submit responses to the questions at 86. The required complexity of the response may increase in later rounds as the total number of remaining contestants decrease.

This example method 50 continues until the final round where the top five contestants compete for the top five prizes. The voter accumulating the most votes in this round is declared the winner of the competition at 90. The four other contestants also receive prizes, which may correspond to the number of votes received during the final round of competition or all the rounds combined.

In some examples, advertisers sponsor some of the prizes and awards in exchange for advertising on the site at 94. The advertiser prizes and awards are in addition to portions of the prize money supplied by the registered voter registration fees.

Provided they are a registered voter, anyone with wide area network access and ability to view the interviews may vote at 74. In this example, to register, a potential voter provides their email address, demographic information, and creates a user name and password to access the website. Voters may only vote for a specified number of contestants each day in this example.

Once registered, the method 50 may include referring to the registered voters as Innovoters, for example. Potential voters pay a fee through a website to become Innovoters, and may complete a survey for advertisers as a portion of the registration process. A portion of the registration fees serve as the contestant rewards. An example breakdown of a registration fee, say a $7.95 registration fee, may include the following: non-profit organizations or charitable organizations receiving $1.00, colleges and universities receiving $2.00 for researching causes related to the general theme of the competition (Innovoters and the panel members may decide the appropriate colleges and universities), and $3.95 goes to administrative or other fees. The contestants receive the remaining $1.00 as prize money.

In one example, $100 corresponds to receiving 100 votes at one penny per vote. Thus, a contestant eliminated after receiving 30,000 votes would receive no less than $300 in prize money. Referring again to the FIG. 1 example with continuing reference to FIG. 2, the registered voters are limited to casting five votes in any given round of the competition 22 and 26. Potential voters registering during later rounds of the competition pay a reduced registration fee, for example, the $7.95 registration charge will be lowered by $0.05 cents per week after the voting starts. Thus, later registering voters are not given more potential votes than earlier registering voters. Further, the earlier weeks of the competition may receive one potential vote for each penny available to vote. As the competition progresses however, the cost of casting a single vote may increase to 5 cents per vote.

Potential votes are stored in each registered voter account. Potential votes may roll-over from round to round if they are not used, which allows that particular registered voter to access the same number of potential votes the next round. Accordingly, the registered voter may develop a strategy to determine the appropriate round to cast their votes. Alternatively, the amount received in each voting round, e.g., every week, does not roll-over to the next week. Instead, each of the contestants starts at zero at the start of each round.

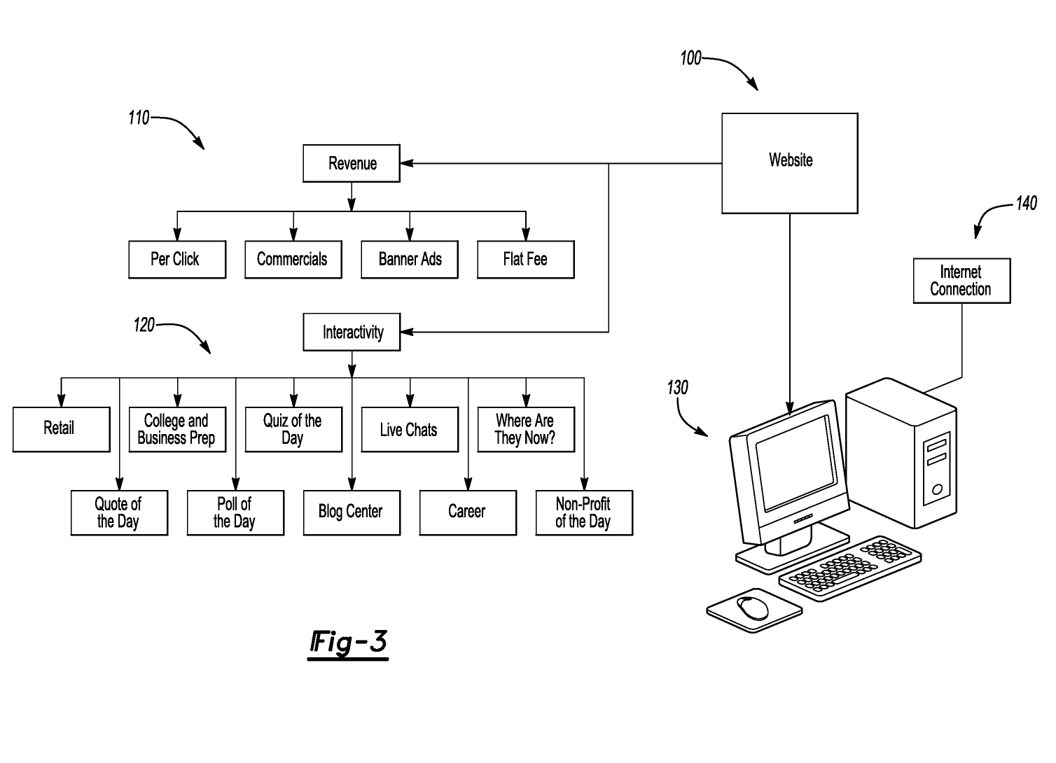

Referring to the FIG. 3 schematic with continuing reference to FIG. 2, an example wide area network website 100 for running the example method 50 may include several features directed toward generating revenue 110 for the website 100 and user interaction 120 with the website 100. The voter views the website 100 using a personal computer 130. An wide area network connection 140 links the computer 130 to other computers and communicates example method 50 to the voter.

Revenue 110 from the website 100 may contribute to awarding the final contestant at 90 and may provide profit for a group running the example method 50. Revenue 110 may result from advertisers paying based on visitors to the website 100 or voters clicking on the advertisements on the website 100. Also, advertisers may pay a flat fee to run brief product commercials played before the responses to new questions at 86. The website may include a news headlines box or banner advertisement. Vendors, such as the web cam manufactures, also pay flat fee charges.

To facilitate user interaction with the website 100 at 58, the website 100 includes a quiz of the day relating to a specific global issue and written by a panel member. The correct answers appear instantly, although the results are typically broadcast the next day. The example website 100 provides an interface for wide area network chats with panel members, and a section describing a non-profit organization of the week chosen by panel members. Other website 100 sections may include a quote of the day, a poll of the day (percentage-based results appear instantly in one example), a blog center for registered voters to share their opinions, and a “preparing for college” and “preparing for business section.” A career section may include classified advertising.

In another area of the example website 100, an alumni section includes a “Where Are They Now?” section and a retail section for distributing products related to the example method 50. For example, video games, software, related to the example method 50 that are sold through a section of the website 100. Other areas may include links to partners, such as movies and television programs, or links to submit essays or resumes to employers advertising on the website 100. Additional partners may include companies that distribute toy characters and other products associated with the website 100.

The website 100 may include portions that open and close depending on the competition phase. In one example, a first phase of competition introduces website characters to potential voters (such as a “Brainstorm” character), a visual meter showing the number of registered voters, a registration page (for registering the potential voter), a name character page, a mentor page, and a page notifying the potential voter of upcoming website 100 developments. In addition, to voting at 74, registered voters may participate in a contest to establish the names of the unnamed characters using the name character page interface. The registered voters may similarly participate in other types of ongoing contests.

In a second phase (approximately 4-6 weeks later), the website 100 opens an essay submission section, a section for registered voters to place classified ads, and a character design portion (for registered voters to design a character villan). Approximately 2-3 weeks later phase three of the website 100 is revealed, which shows the competition winners, and provides access to a blog for registered voters to write their thoughts on the competition. Mentor pages listing charitable causes submitted by competition mentors open in another 2-3 weeks during phase four of the competition. The website also includes a quiz of the week section during this time.

The open voting for the registered voters at 70 begins approximately 2-3 weeks later during phase five. During this phase, a ballot page also opens explain the voting process for the registered voters. The competition then advances through future phases according to the round of competition (round two corresponding to phase six, round three corresponding to phase seven, etc.) and also shows the entries eliminated in prior rounds.

Although a preferred embodiment of this invention has been disclosed, a worker of ordinary skill in this art would recognize that certain modifications would come within the scope of this invention. For that reason, the following claims should be studied to determine the true scope and content of the prior art.

I claim:

1) A method of conducting a competition over a wide area network, comprising:
a) receiving a fee from at least one user;
b) allocating a quantity of potential votes to the at least one user in response to the fee;
c) displaying competition entries for evaluation by the at least one user; and
d) receiving a vote from the at least one user corresponding to at least one of the competition entries.

2) The method of claim 1, including the step of:
e) awarding the competition entry based on the vote

3) The method of claim 2, said step (e) includes awarding a portion of the fee.

4) The method of claim 1, including the step of:
e) eliminating a competition entry based on the vote.

5) The method of claim 1, wherein said step d) includes reducing the quantity of potential votes based on receiving the vote.

6) The method of claim 5, wherein receiving the vote reduces by one the quantity of potential votes.

7) The method of claim 1, wherein said step d) includes receiving a vote during a first round of competition.

8) The method of claim 7 including the step of:
e) receiving a vote during another round of competition from the at least one user corresponding to at least one of the competition entries.

9) A method of conducting a wide area network competition, comprising:
a) receiving a fee from a plurality of users;
b) providing access to a website for review of a plurality of competition entries by the plurality of users;
c) allocating potential votes to the plurality of users based on the user access fees;
d) receiving votes for at least one of the plurality of competition entries from at least one of the plurality of users; and
e) preventing receiving one or more votes based on a number of allocated potential votes.

10) The method of claim 9, including the step of:
f) awarding a greater portion of the user access fees to the one of the plurality of competition entries receiving a greater portion of votes than another of the plurality of competition entries receiving a lesser portion of votes.

11) The method of claim 9, wherein said step c) includes allocating more potential votes to one of the plurality of users paying a higher user access fee than one of the plurality of users paying a lower user access fee.

12) The method of claim 9, wherein said step d) includes receiving one or more votes in more than one round of competition.

13) The method of claim 9, wherein said step d) includes verifying at least one of the plurality of users has one or more potential votes before receiving one more votes.

14) The method of claim 9, wherein said step a) includes receiving the fee through another website.

15) The method of claim 9, wherein said step b) includes video review of a plurality of competition entries.

16) The method of claim 9, including the step of providing access to a portion of the website to view the number of allocated potential votes.

17) The method of claim 9, including the step of providing access to a portion of the website to view the number of received votes.
